(19) United States
(12) Patent Application Publication
(10) Pub. No.: US 2022/0376377 A1
(43) Pub. Date: Nov. 24, 2022

(54) ANTENNA RADIATOR CONNECTIONS

(71) Applicant: HEWLETT-PACKARD DEVELOPMENT COMPANY, L.P., Spring, TX (US)

(72) Inventors: Pai-Cheng Huang, Taipei City (TW); Chin-Hung Ma, Taipei City (TW); Po Chao Chen, Taipei City (TW)

(73) Assignee: HEWLETT-PACKARD DEVELOPMENT COMPANY, L.P., Spring, TX (US)

(21) Appl. No.: 17/323,156

(22) Filed: May 18, 2021

(51) Int. Cl. H01Q 1/22; G06F 1/16

(52) U.S. Cl. CPC H01Q 1/2266; G06F 1/1618

(57) ABSTRACT

In one example in accordance with the present disclosure, an electronic device is described. An example electronic device includes an antenna. The example antenna includes a feed point and a first radiator coupled to the feed point. The example antenna also includes a switch coupled to the first radiator and a second radiator coupled to the switch. The example switch (1) disconnects the first radiator from the second radiator when the electronic device is in a first mode; and (2) connects the first radiator to the second radiator when the electronic device is in a second mode.

### BACKGROUND

Electronic devices include wireless antennas to transmit information between electronic devices that are not physically connected to one another. Antennas wirelessly communicate with other antennas using radio frequency (RF) waves. In some cases, antennas are used to communicate over a wireless network. Different wireless networks include different communication protocols and the antennas that are a part of a wireless network communicate in compliance with those protocols. One example of a wireless network is a Wi-Fi network. Another example of a wireless network is a long-term evolution (LTE) network.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an electronic device to switch antenna radiator connections, according to an example.

FIG. 2 depicts examples of different modes of a convertible laptop, according to an example.

FIG. 3 depicts examples of different modes of an electronic device with a 360-degree hinge, according to an example.

FIG. 4 depicts examples of different modes of an electronic device with a pull-forward hinge, according to an example.

FIG. 5 is a block diagram of an electronic device to switch antenna radiator connections, according to an example.

FIG. 6 is a block diagram of an electronic device to switch antenna radiator connections, according to an example.

FIG. 7 is a flowchart of a method for switching antenna radiator connections, according to an example.

FIG. 8 is a flowchart of a method for switching antenna radiator connections, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In some examples, electronic devices may include a number of antennas to facilitate wireless communication. For example, an electronic device may include a Wi-Fi antenna that allows the electronic device to transmit and receive information via a Wi-Fi network. As another example, the electronic device may include an LTE antenna that allows the electronic device to transmit and receive information via an LTE network. Each of these different networks incorporate different communication protocols. As the different wireless networks have different operating parameters and communication protocols, each may be particularly tailored to a particular environment.

While wireless communication has undoubtedly shaped the way in which society communicates with one another, some characteristics limit their more thorough implementation. For example, in a user environment, objects may be subjected to energy emitted by an antenna. This energy may be in the form of radio waves.

In some examples, the radio waves may be absorbed by the human body. The absorption of the radio waves by the human body may cause harm to the individual. Accordingly, some entities such as governments regulate communications devices by imposing a restriction on how much radio frequency (RF) energy they may emit so as to limit the amount of RF energy a user absorbs. This restriction may be referred to as a specific absorption rate (SAR) threshold.

In the field of wireless communication, SAR values are regulated. As used herein, a SAR value is the rate that a human body absorbs energy when exposed to an RF electromagnetic field. The radio transmission power is directly related to the SAR value. The radio transmission power may be restricted to ensure compliance with SAR regulations. In some approaches, the effect of the radio waves on the human body may be reduced by reducing the RF transmission power.

However, reducing the transmission power of antenna to reduce the SAR value may decrease the range over which the antenna can communicate. The transmission power is directly related to data throughput, where lower transmission power may result in lower data throughput performance. In this example, the lower data throughput may negatively impact the user experience.

In another approach, radiators may be positioned in an electronic device to create an offset from where a human body is likely to encounter radio waves. As used herein, a “radiator” is a component of an antenna that emits radio waves (also referred to as RF waves). In some examples, a radiator may be formed from an electrically conductive material. The offset of a radiator from an external surface of the electronic device may be referred to as an SAR spacing. For example, by increasing the distance of a radiator from the exterior surface of the electronic device, the SAR value experienced by a human may be reduced. Thus, SAR spacing may be used to meet SAR regulations with higher transmission power. However, increasing the SAR spacing may impact the visual appearance of the electronic device. For example, if the antenna is located within the frame of a display device, a large SAR spacing may result in a large border, which reduces the screen-to-body ratio of the display device.

The SAR value is impacted by the location of antenna radiators. In some examples, the present specification describes electronic devices that dynamically switch the SAR spacing of an antenna based on a mode of the electronic device. More specifically, the mode of the electronic device may be determined. A switch may connect or disconnect a first radiator and a second radiator.

Specifically, the present specification implements an electronic device with an antenna. The antenna includes a first radiator coupled to a feed point, which receives an alternating current of radio frequency. The antenna also includes a second radiator. A switch disconnects the first radiator from the second radiator when the electronic device is in a first mode. The switch connects the first radiator to the second radiator when the electronic device is in a second mode. Therefore, when the electronic device is in the first mode, the first radiator transmits radio waves and the second radiator is disabled. When the electronic device is in the second mode, both the first radiator and the second radiator are used to transmit radio waves. By disconnecting the second radiator in certain modes of the electronic device, the SAR spacing may be adjusted to account for scenarios where a human is likely to encounter radio waves.

In an example, the present specification describes an electronic device. The electronic device includes an antenna. In this example, the antenna includes a feed point and a first radiator coupled to the feed point. A switch is coupled to the first radiator. A second radiator is coupled to the switch. The switch is to 1) disconnect the first radiator from the second radiator when the electronic device is in a first mode; and 2) connect the first radiator to the second radiator when the electronic device is in a second mode.

In another example, the present specification also describes an electronic device that includes an antenna. In this example, the antenna includes a first set of radiators. The antenna also includes a second set of radiators that is larger than the first set of radiators. The electronic device also includes a controller to 1) determine a mode of the electronic device; 2) use the first set of radiators for a first mode of the electronic device; and 3) use the second set of radiators for a second mode of the electronic device.

In yet another example, the present specification also describes an electronic device that includes a housing. In this example, the electronic device also includes an antenna located in the housing. The antenna includes a first radiator located at a first position in the housing. A switch is coupled to the first radiator. The antenna also includes a second radiator coupled to the switch. The second radiator is located at a second position in the housing. In this example, the switch connects the first radiator to the second radiator based on a mode of the electronic device.

As used in the present specification and in the appended claims, the term, “controller” may be a processor, an application-specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer-usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the respective component, cause the component to implement the functionality described herein.

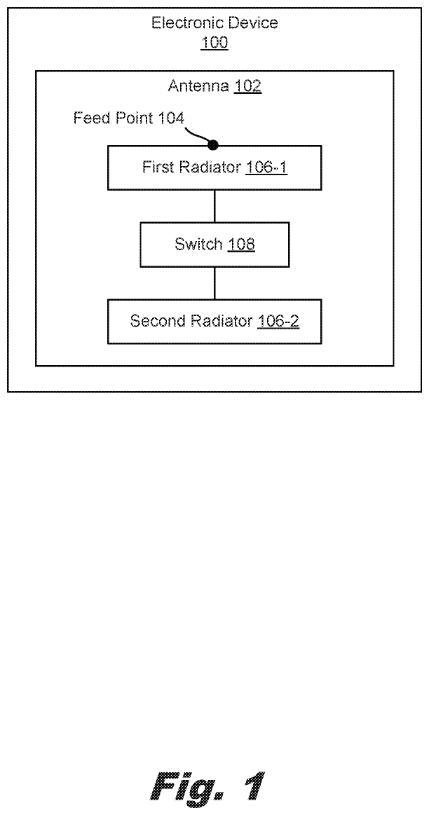

Turning now to the figures, FIG. 1 is a block diagram of an electronic device 100 to switch antenna radiator connections, according to an example. As described above, the electronic device 100 includes an antenna 102. In some examples, the antenna 102 includes a first radiator 106-1 and a second radiator 106-2. The first radiator 106-1 may be coupled to a feed point 104 of the antenna 102. As used herein, a feed point 104 is a location at which a radiator receives an RF frequency. In this example, the first radiator 106-1 may transmit radio waves based on the RF frequency received at the feed point 104.

In some examples, the antenna 102 also includes a second radiator 106-2. The second radiator 106-2 may be connected to and disconnected from the first radiator 106-1 by a switch 108. In some examples, the switch 108 may be coupled to both the first radiator 106-1 and the second radiator 106-2. When the first radiator 106-1 and the second radiator 106-2 are connected by the switch 108, the RF frequency received at the feed point 104 may be electrically communicated to the second radiator 106-2. Therefore, when the first radiator 106-1 and the second radiator 106-2 are connected, then both the first radiator 106-1 and the second radiator 106-2 may transmit radio waves. However, when the first radiator 106-1 is disconnected from the second radiator 106-2, then the first radiator 106-1 may transmit radio waves and the second radiator 106-2 is disabled (i.e., may not be able to transmit radio waves).

In some examples, the switch 108 may be a PIN-diode. In some examples, the PIN-diode may include a pin to receive a signal to change the state (e.g., open, closed) of the PIN-diode. For example, the PIN-diode may disconnect the first radiator 106-1 from the second radiator 106-2 in response to a pin OFF signal at the PIN-diode. In an example, the PIN-diode may connect the first radiator 106-1 to the second radiator 106-2 in response to a pin ON signal at the PIN-diode.

It should be noted that while the switch 108 may be implemented as a PIN-diode in some examples, in other examples, the switch 108 may be implemented with other circuitry. For example, the switch 108 may be a metal-oxide-semiconductor field-effect transistor (MOSFET) or other transistor.

In some examples, the switch 108 may connect and disconnect the first radiator 106-1 and the second radiator 106-2 based on a mode of the electronic device 100. The electronic device 100 may be of a variety of types including a desktop computer, a laptop computer, a tablet, a smart phone, or any other electronic device 100 that includes an antenna 102. The electronic device 100 may operate in different modes.

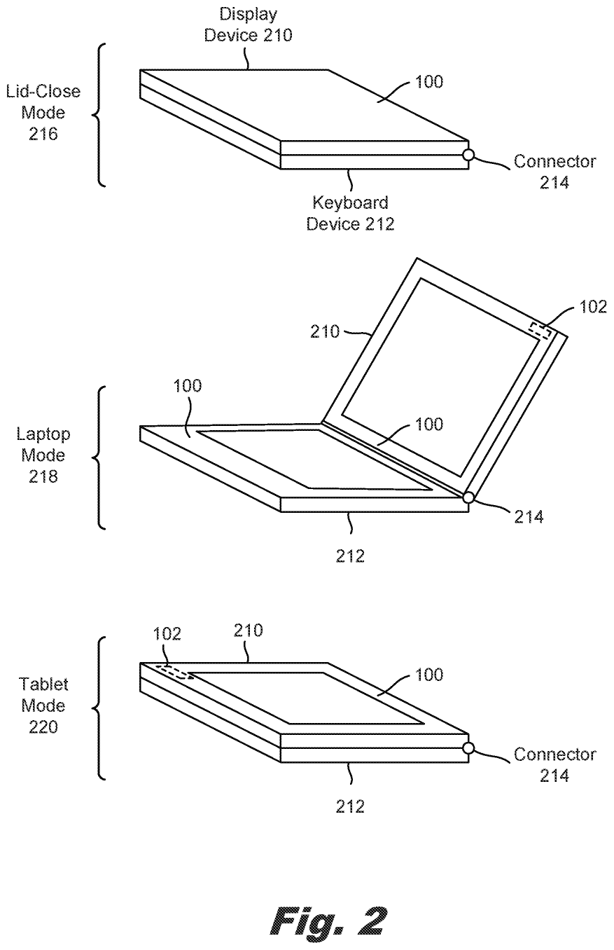

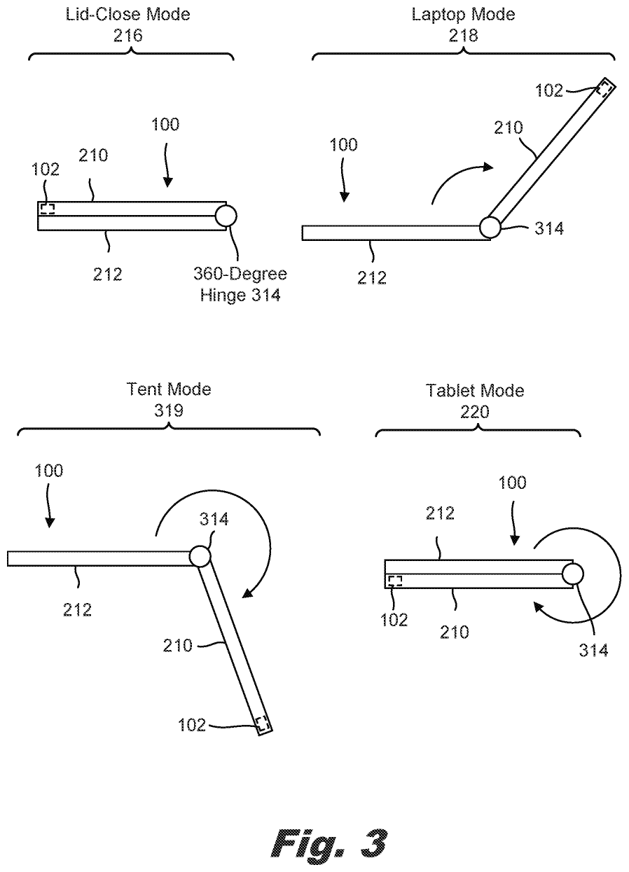

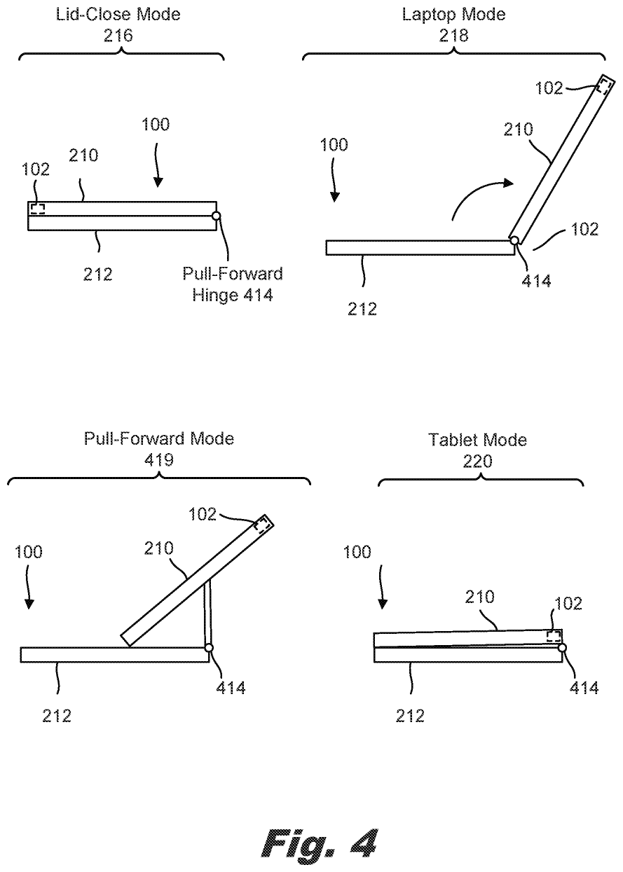

In some examples, the electronic device 100 may be a convertible laptop (also referred to as a 2-in-1 laptop or 2-in-1 convertible laptop). A convertible laptop may function as a laptop in a laptop mode and a tablet in a tablet mode. Examples of different modes of a convertible laptop are described in FIG. 2. Examples of modes for different types of convertible laptops are described in FIGS. 3 and 4.

Referring briefly to FIG. 2, the electronic device 100 includes a display device 210 and a keyboard device 212. A connector 214 may couple the display device 210 to the keyboard device 212. The connector 214 may allow the display device 210 to change position relative to the keyboard device 212. Examples of the connector 214 include a hinge, a 360-degree hinge and/or a pull-forward hinge. In some examples, the connector 214 may allow the display device 210 to swivel relative to the keyboard device 212. In some examples, the connector 214 may allow the display device 210 to disconnect from the keyboard device 212. In this case, the connector 214 may allow the display device 210 to be connected in a different position relative to the keyboard device 212.

In an example of a mode of the electronic device 100, the electronic device 100 may be in a lid-close mode 216. For example, the display device 210 may be positioned on the connector 214 such that a screen of the display device 210 is positioned next to the keyboard of the keyboard device 212. In this case, the convertible laptop may be in a closed or shut position.

In some examples, the electronic device 100 may be in a laptop mode 218 (also referred to as notebook mode or NB mode). For example, the display device 210 may be positioned on the connector 214 such that a screen of the display device 210 is visible on the exterior of the electronic device 100. In laptop mode 218, the display device 210 may be positioned by the connector 214 at an angle relative to the keyboard device 212 such that the display device 210 is not in contact with the keyboard device 212.

In some examples, the electronic device 100 may be in a tablet mode 220. For example, the display device 210 may be positioned on the connector 214 such that a screen of the display device 210 is visible on the exterior of the electronic device 100. In tablet mode 220, the display device 210 may contact the keyboard device 212.

In some examples, the antenna 102 may be located in a housing within the display device 210. For example, the antenna 102 may be located in a border frame of the display device 210. In some examples, the antenna 102 may be placed in the top of the display border as determined by the position of the display device 210 in laptop mode 218.

Referring now to FIG. 3, in this example, side views of an electronic device 100 in different modes are depicted. In this example, the electronic device 100 includes a 360-degree hinge 314 to couple the display device 210 to the keyboard device 212. The 360-degree hinge 314 may allow the display device 210 to rotate about an axis. The display device 210 may rotate about the axis between 0 and approximately 360 degrees.

In some examples, the mode of the electronic device 100 may be based on the amount of rotation of the display device 210 on the 360-degree hinge 314. For example, at 0 degrees, the electronic device 100 may be in lid-close mode 216. Between 0-180 degrees, the electronic device 100 may be in laptop mode 218. Between 180-360 degrees, the electronic device 100 may be in a tent mode 319. At 360 degrees, the electronic device 100 may be in tablet mode 220.

Referring now to FIG. 4, in this example, side views of an electronic device 100 in different modes are depicted. In this example, the electronic device 100 includes a pull-forward hinge 414 to couple the display device 210 to the keyboard device 212. In lid-close mode 216, the pull-forward hinge 414 may allow the display device 210 to contact the keyboard device 212 such that the screen of the display device 210 is concealed. In laptop mode 218, the display device 210 may rotate about a first axis of the pull-forward hinge 414 over a range of degrees such that the keyboard of the keyboard device 212 and the screen of the display device 210 are visible to a user. In a pull-forward mode 419, the display device 210 may rotate about a first axis and a second axis of the pull-forward hinge 414 such that the screen of the display device 210 is visible, but the display device 210 covers a portion of the keyboard device 212. In tablet mode 220, the display device 210 may contact the keyboard device 212 such that the screen of the display device 210 is visible on the exterior of the electronic device 100.

Referring again to FIG. 1, the switch 108 may connect and disconnect the first radiator 106-1 and the second radiator 106-2 based on a mode of the electronic device 100. For example, the switch 108 may disconnect the first radiator 106-1 from the second radiator 106-2 when the electronic device 100 is in a first mode. Thus, in the first mode, the first radiator 106-1 may transmit radio waves and the second radiator 106-2 is disabled. In some examples, the first mode may be tablet mode 220 as described in FIGS. 2-4.

In some examples, the switch 108 may connect the first radiator 106-1 to the second radiator 106-2 when the electronic device 100 is in a second mode. Therefore, in the second mode, both the first radiator 106-1 and the second radiator 106-2 may transmit radio waves. In some examples, the second mode may be a mode other than tablet mode 220. For example, the second mode may be lid-close mode 216, laptop mode 218, tent mode 319, pull-forward mode 419, as described in FIGS. 2-4.

In some examples, the electronic device 100 also includes a controller. As described above, “controller” refers to various hardware components, which include a processor and memory. The processor includes the circuitry to retrieve executable code from the memory and execute the executable code.

In some examples, the controller may determine the mode of the electronic device 100. For example, the controller may determine whether the electronic device 100 is in a first mode (e.g., tablet mode) or a second mode (e.g., laptop mode, lid-close mode, etc.). In some examples, the electronic device 100 may include a sensor to indicate to the controller the mode of the electronic device 100. For instance, a sensor may detect the position of the display device relative to the keyboard device. Based on information from the sensor, the controller may determine the mode of the electronic device 100.

In some examples, the controller may indicate a state (e.g., open, closed) to the switch 108 based on the mode of the electronic device 100. For example, the controller may send a signal to the switch 108 indicating that the electronic device 100 is in a first mode (e.g., tablet mode) or a second mode (e.g., laptop mode, lid-close mode, etc.). Upon receiving the signal, the switch 108 may connect or disconnect the first radiator 106-1 and second radiator 106-2.

In some examples, the controller may send a first signal (e.g., a pin OFF signal, OFF signal, etc.) to cause the switch 108 to disconnect the first radiator 106-1 from the second radiator 106-2 when the electronic device 100 is in a first mode. In some examples, the first signal may be a voltage low on a pin of the switch 108.

In some examples, the controller may send a second signal (e.g., a pin ON signal, ON signal, etc.) to cause the switch 108 to connect the first radiator 106-1 to the second radiator 106-2 when the electronic device 100 is in a second mode. In some examples, the second signal may be a voltage high on a pin of the switch 108.

In some examples, the switch 108 may dynamically connect or disconnect the first radiator 106-1 and second radiator 106-2 based on an SAR spacing used for a given mode of the electronic device 100. As described above, SAR thresholds are regulated to ensure that a human using the electronic device 100 is not exposed to radio wave radiation above a threshold amount.

In some examples, a user may be likely to be in close contact with an antenna 102 in some modes of the electronic device 100 and may not be likely to be near the antenna 102 in other modes of the electronic device 100. For example, in the case of a convertible laptop, when the convertible laptop is in tablet mode, it is likely that a user will contact (e.g., hold) the convertible laptop near the antenna 102. In this case, SAR regulations specify that if a human is likely to be within a specified distance (e.g., less than 20 centimeters (cm)) between the antenna 102, then the SAR value is to be within a threshold amount. However, when the convertible laptop is in a mode other than tablet mode, then a user is unlikely to contact the convertible laptop near the antenna 102. In this case, a human is likely to be more than the specified distance, and SAR testing is not performed.

To address a mode (e.g., tablet mode) where SAR testing may be performed and a mode (e.g., laptop mode, lid-close mode, tent mode, etc.) where SAR regulations do not call for testing, the switch 108 may adjust SAR spacing by connecting or disconnecting the second radiator 106-2 from the first radiator 106-1. For example, in the case of tablet mode, the distance from the antenna 102 to a human is less than 20 cm. In this case, the switch 108 may disconnect the second radiator 106-2 from the first radiator 106-1 to increase the space between an exterior surface of the electronic device 100 and the source (i.e., the first radiator 106-1) of radio waves from the antenna 102.

In some examples, SAR regulations do not call for testing of the SAR value of the antenna 102 when the electronic device 100 is operating in a given mode. For example, in the case of laptop mode where the lid is open, the distance from the antenna 102 to a human is greater than 20 cm. In other examples, such as lid-close mode, SAR testing is not performed due to regulatory definition. In the examples of modes where SAR regulations do not call for testing, the switch 108 may connect the second radiator 106-2 to the first radiator 106-1.

The combined radiators 106-1, 106-2 result in a larger radiator, which may increase the throughput of the antenna 102, thus enhancing antenna performance. Therefore, by determining that the electronic device 100 is in a mode where SAR testing is not mandated by regulations, the antenna 102 may use the combined radiators 106-1, 106-2 to enhance antenna performance and user experience.

Accordingly, the present specification describes an electronic device 100 with an antenna 102 that switches a connection between a first radiator 106-1 and a second radiator 106-2 based on the mode of the electronic device 100. Rather than having a single radiator with fixed size and position in the electronic device 100, multiple radiators 106-1, 106-2 may be connected or disconnected to adjust the radiator size and radiator spacing. By disconnecting the second radiator 106-2 from the first radiator 106-1 when the electronic device 100 is in a first mode (e.g., tablet mode), the antenna 102 may meet SAR regulations. By connecting the second radiator 106-2 to the first radiator 106-1 when the electronic device 100 is in a second mode (e.g., laptop mode, lid-close mode, etc.) where SAR regulations do not apply, the performance of the antenna 102 may be enhanced. Furthermore, the examples described herein may be applied to different types of antennas 102 (e.g., wireless local area network (WLAN) antennas, wireless wide area network (WWAN) antennas, etc.) where SAR testing is to be performed.

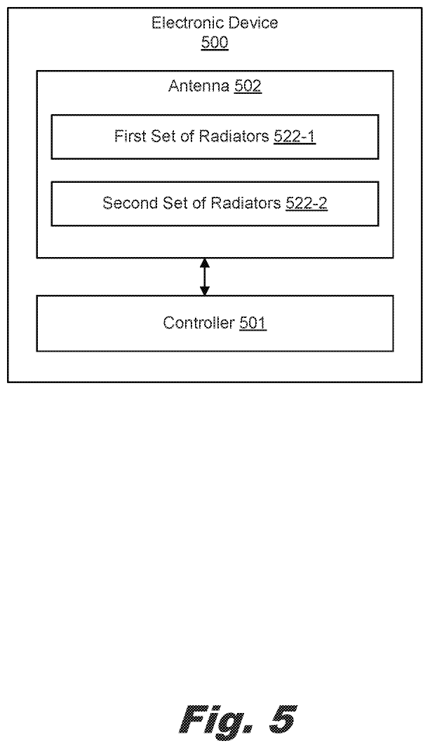

FIG. 5 is a block diagram of an example of an electronic device 500 to switch antenna radiator connections. As described above, an electronic device 500, such as a laptop computer, may have an antenna 102. In some examples, the antenna 102 may include a first set of radiators 522-1 and a second set of radiators 522-1.

The first set of radiators 522-1 may include a number of radiators. For example, the first set of radiators 522-1 may include one radiator, two radiators, three radiators, etc. The radiators may be implemented as described in FIG. 1.

The second set of radiators 522-2 may include a number of radiators. For example, the second set of radiators 522-2 may include one radiator, two radiators, three radiators, etc. The radiators may also be implemented as described in FIG. 1.

In some examples, the second set of radiators 522-2 may include a single radiator, or multiple radiators, that are different than the radiators included in the first set of radiators 522-1. In some examples, the second set of radiators 522-2 may include a portion of the radiators in the first set of radiators 522-1 and additional radiators. In this case, the first set of radiators 522-1 may be a subset of the second set of radiators 522-2. In the example of FIG. 1, the first radiator 106-1 may be included in the first set of radiators 522-1. Also, in the example of FIG. 1, the first radiator 106-1 and second radiator 106-2 connected by the switch 108 may be included in the second set of radiators 522-2.

The second set of radiators 522-2 is larger than the first set of radiators 522-1. For example, the total size of the radiators included in the second set of radiators 522-2 is greater than the total size of the radiators included in the second set of radiators 522-2.

FIG. 5 also depicts the controller 501 to determine the mode of the electronic device 500. As described above, the controller 501 may determine whether the electronic device 500 is in a first mode (e.g., tablet mode) or a second mode (e.g., laptop mode, lid-close mode, etc.).

The controller 501 may use the first set of radiators 522-1 or the second set of radiators 522-2 based on the mode of the electronic device 500. For example, the controller 501 may use the first set of radiators 522-1 for a first mode of the electronic device 500. The controller 501 may use the second set of radiators 522-2 for a second mode of the electronic device 500.

In some examples, the controller 501 may use the first set of radiators 522-1 in response to determining that the electronic device 500 is in a tablet mode. For example, the electronic device 500 may be a convertible laptop. In this case, the controller 501 may use the first set of radiators 522-1 for transmitting radio waves when the electronic device 500 is in tablet mode. It should be noted that because the first set of radiators 522-1 is smaller than the second set of radiators 522-2, using the first set of radiators 522-1 may reduce the SAR value for tablet mode.

In some examples, the controller 501 may use the second set of radiators 522-2 in response to determining that the electronic device 500 is in a laptop mode or a lid-close mode. In the example of a convertible laptop, the controller 501 may use the second set of radiators 522-2 for transmitting radio waves when the electronic device 500 is in laptop mode or lid-close mode. It should be noted that because the second set of radiators 522-2 is larger than the first set of radiators 522-1, using the second set of radiators 522-2 may enhance the performance and throughput of the antenna 502 for laptop mode or lid-close mode.

Using the example of FIG. 3, the electronic device 500 may include a display device 210, a keyboard device 212, and a 360-degree hinge 314 to couple the display device 210 to the keyboard device 212. In this example, the controller 501 may use the first set of radiators 522-1 in response to determining that the display device 210 is rotated on the 360-degree hinge 314 to a tablet mode 220 with respect to the keyboard device 212. The controller 501 may use the second set of radiators 522-2 in response to determining that the display device 210 is rotated on the 360-degree hinge 314 to a mode (e.g., laptop mode 218, lid-close mode 216, tent mode 319) other than tablet mode 220.

In the case of the example of FIG. 4, the electronic device 500 may include a display device 210, a keyboard device 212, and a pull-forward hinge 414 to couple the display device 210 to the keyboard device 212. In this example, the controller 501 may use the first set of radiators 522-1 in response to determining that the display device 210 is positioned on the pull-forward hinge 414 in a tablet mode 222 with respect to the keyboard device 212. The controller 501 may use the second set of radiators 522-2 in response to determining that the display device 210 is positioned on the pull-forward hinge 414 in a mode (e.g., laptop mode 218, lid-close mode 216, pull-forward mode 419, etc.) other than tablet mode 220.

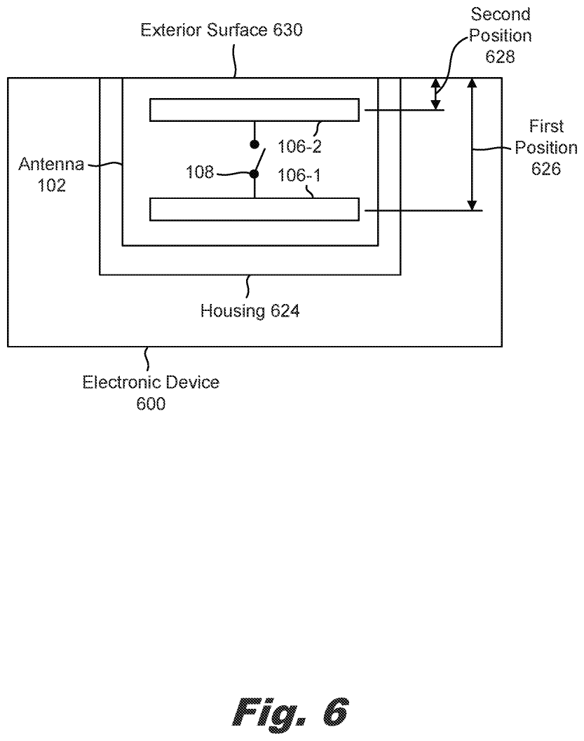

FIG. 6 is a block diagram of an example of an electronic device 600 to switch antenna radiator connections. As described above, an electronic device 600, such as a laptop computer, may have an antenna 102. In some examples, the antenna 102 may include a first radiator 106-1 and a second radiator 106-2, as described in FIG. 1. The antenna 102 may also include a switch 108 coupled to the first radiator 106-1 and the second radiator 106-2. The switch 108 may connect the first radiator 106-1 to the second radiator 106-2 based on a mode of the electronic device.

The electronic device 600 also include a housing 624. In some examples, the housing 624 may be an enclosure and/or recess located within the body of the electronic device 600. In some examples, the housing 624 may be located at an exterior surface 630 of the electronic device 600. For instance, the housing 624 may be located at a top edge of the display device of the electronic device 600.

The antenna 102 may be located in the housing 624. For example, the antenna 102 may be attached to the housing 624 within the body of the electronic device 600.

To achieve different SAR spacings based on the mode of the electronic device 600, the radiators 106-1, 106-2 may be in different locations with respect to the exterior surface 630 of the electronic device 600. In some examples, the first radiator 106-1 may be located at a first position 626 in the housing 624. The second radiator 106-2 may be located at a second position 628 in the housing 624. In some examples, the first radiator 106-1 is located farther from the exterior surface 630 of the electronic device 600 than the second radiator 106-2.

The SAR spacing of the antenna 102 may be changed based on whether the second radiator 106-2 is connected to the first radiator 106-1. As used herein, the SAR spacing of the antenna 102 refers to the distance of the radio wave source from the exterior surface 630. In some examples, the switch 108 may disconnect the first radiator 106-1 from the second radiator 106-2 to increase the SAR spacing of the antenna with respect to the exterior surface 630. For example, when the electronic device 600 is in a first mode (e.g., tablet mode), the switch 108 may disconnect the second radiator 106-2 from the first radiator 106-1. When the second radiator 106-2 is disconnected from the first radiator 106-1, the source of radio wave transmission corresponds to the first position 626.

In some examples, the switch 108 may connect the first radiator 106-1 to the second radiator 106-2 to decrease the SAR spacing of the antenna with respect to the exterior surface 630. For example, when the electronic device 600 is in a second mode (e.g., laptop mode, lid-close mode), the switch 108 may connect the second radiator 106-2 to the first radiator 106-1. When the second radiator 106-2 is connected to the first radiator 106-1, the source of radio wave transmission corresponds to the second position 628.

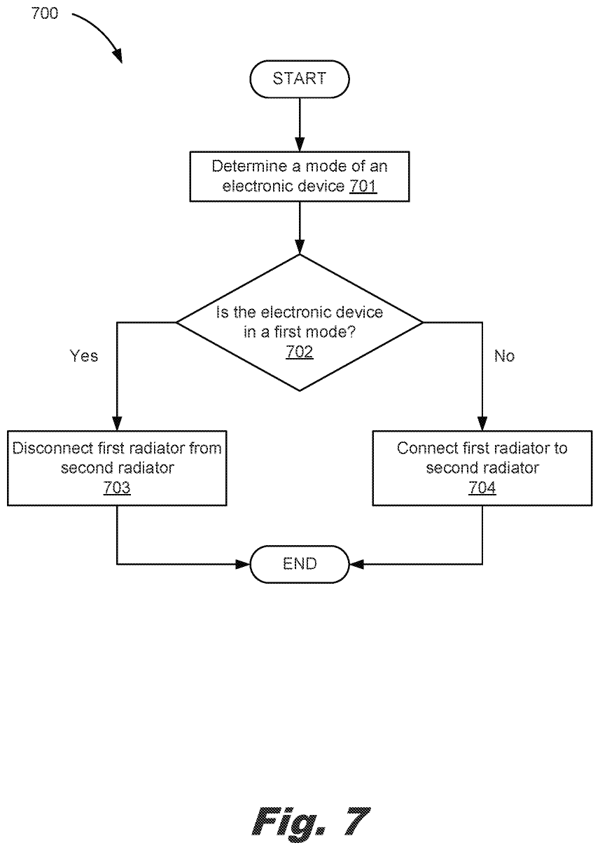

FIG. 7 is a flowchart of a method 700 for switching antenna radiator connections, according to an example. The method 700 is described with reference to the electronic device 100 described in FIG. 1.

The method 700 includes determining 701 a mode of the electronic device 100. For example, a controller may determine whether the electronic device 100 is in a first mode (e.g., tablet mode) or a second mode (e.g., laptop mode, lid-close mode).

If the electronic device 100 is in the first mode, 702 determination YES, then the switch 108 may disconnect 703 the first radiator 106-1 from the second radiator 106-2. In this case, the first radiator 106-1 may transmit radio waves and the second radiator 106-2 is disabled. If the electronic device 100 is not in the first mode, 702 determination NO, then the switch 108 may connect 704 the first radiator 106-1 to the second radiator 106-2. In this case, both the first radiator 106-1 and the second radiator 106-2 may transmit radio waves.

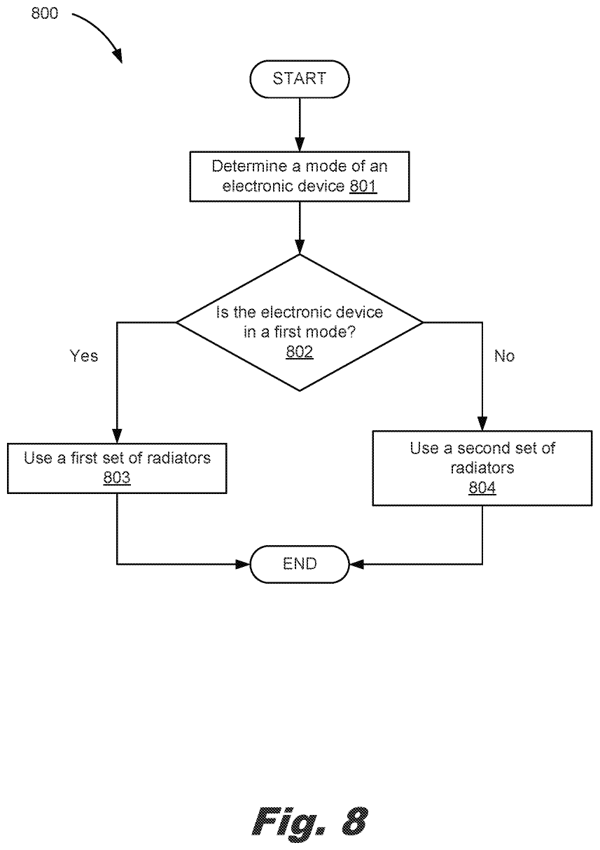

FIG. 8 is a flowchart of a method 800 for switching antenna radiator connections, according to an example. The method 800 is described with reference to the electronic device 500 described in FIG. 5.

The method 800 includes determining 801 a mode of the electronic device 500. For example, a controller 501 may determine whether the electronic device 500 is in a first mode (e.g., tablet mode) or a second mode (e.g., laptop mode, lid-close mode).

If the electronic device 500 is in the first mode, 802 determination YES, then the controller 501 may use 803 the first set of radiators 522-1. In this case, the first set of radiators 522-1 may transmit radio waves. If the electronic device 500 is not in the first mode, 802 determination NO, then the controller 501 may use 804 a second set of radiators 522-2. In this case, the second set of radiators 522-2 may be larger than the first set of radiators 522-1. When the electronic device 500 is in the second mode, the second set of radiators 522-2 may transmit radio waves.

What is claimed is:

1. An electronic device, comprising:
an antenna, comprising:
a feed point;
a first radiator coupled to the feed point;
a switch coupled to the first radiator; and
a second radiator coupled to the switch, the switch to:
disconnect the first radiator from the second radiator when the electronic device is in a first mode; and
connect the first radiator to the second radiator when the electronic device is in a second mode.

2. The electronic device of claim 1, wherein in the first mode, the first radiator is to transmit radio waves and the second radiator is disabled.

3. The electronic device of claim 1, wherein in the second mode, both the first radiator and the second radiator are to transmit radio waves.

4. The electronic device of claim 1, wherein the switch comprises a PIN-diode.

5. The electronic device of claim 4, wherein the PIN-diode is to:
disconnect the first radiator from the second radiator in response to a pin OFF signal at the PIN-diode; and
connect the first radiator to the second radiator in response to a pin ON signal at the PIN-diode.

6. An electronic device, comprising:
an antenna, comprising:
a first set of radiators; and
a second set of radiators that is larger than the first set of radiators; and
a controller to:
determine a mode of the electronic device;
use the first set of radiators for a first mode of the electronic device; and
use the second set of radiators for a second mode of the electronic device.

7. The electronic device of claim 6, wherein the controller is to use the first set of radiators in response to determining that the electronic device is in a tablet mode.

8. The electronic device of claim 6, wherein the controller is to use the second set of radiators in response to determining that the electronic device is in a laptop mode.

9. The electronic device of claim 6, wherein the electronic device comprises a convertible laptop, and wherein the controller is to use the second set of radiators in response to determining that the electronic device is in a lid-close mode.

10. The electronic device of claim 6, wherein the electronic device further comprises:
a display device;
a keyboard device; and
a 360-degree hinge to couple the display device to the keyboard device,
wherein the controller is to use the first set of radiators in response to determining that the display device is rotated on the 360-degree hinge to a tablet mode with respect to the keyboard device.

11. The electronic device of claim 6, wherein the electronic device further comprises:
a display device;
a keyboard device; and
a pull-forward hinge to couple the display device to the keyboard device,
wherein the controller is to use the first set of radiators in response to determining that the display device is positioned on the pull-forward hinge in a tablet mode with respect to the keyboard device.

12. An electronic device, comprising:
a housing; and
an antenna located in the housing, the antenna comprising:
a first radiator located at a first position in the housing;
a switch coupled to the first radiator; and
a second radiator coupled to the switch, the second radiator being located at a second position in the housing,
the switch to connect the first radiator to the second radiator based on a mode of the electronic device.

13. The electronic device of claim 12, wherein the first radiator is located farther from an exterior surface of the electronic device than the second radiator.

14. The electronic device of claim 13, wherein the switch is to disconnect the first radiator from the second radiator to increase a Specific Absorption Rate (SAR) spacing of the antenna with respect to the exterior surface for a first mode of the electronic device.

15. The electronic device of claim 14, wherein the switch is to connect the first radiator to the second radiator to decrease the Specific Absorption Rate (SAR) spacing of the antenna with respect to the exterior surface.
